(19) United States
(12) Patent Application Publication
(10) Pub. No.: US 2003/0030557 A1
(43) Pub. Date: Feb. 13, 2003

(54) Apparatus and method for detecting intrusion and non-intrusion events

(75) Inventors: Dusan V. Progovac, Grosse Pointe, MI (US); Stephen R.W. Cooper, Fowlerville, MI (US); Brennan J. Trese, Farmington Hills, MI (US)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Inc.

(21) Appl. No.: 09/924,672

(22) Filed: Aug. 8, 2001

(51) Int. Cl. G08B 29/00

(52) U.S. Cl. 340/511; 340/552

(57) ABSTRACT

An apparatus (10) and method for detecting an intrusion into a predetermined area. The apparatus (10) includes a transmitter (28) and a receiver (30). The receiver (30) generates an output signal indicative of reflected return signals received. The apparatus (10) also includes a controller (38). The controller (38) receives the output signal from the receiver (30) and determines a peak value of the output signal during a first time window. The first time window continues no longer than a first maximum duration when the peak value of the output signal during the first maximum duration is at least a predetermined value. The first time window continues no longer than a second maximum duration when the peak value of the output signal during the first maximum duration is less than the predetermined value.

### TECHNICAL FIELD

The present invention relates to an intrusion detection apparatus and method. More particularly, the present invention relates to an apparatus that differentiates between an intrusion into a predetermined area and a non-intrusion event and the method by which the apparatus operates.

### BACKGROUND OF THE INVENTION

Several Apparatus types are known for detecting an intrusion into the passenger compartment of a vehicle. In general, if an intrusion is detected, a known apparatus actuates an alarm. The alarm may include sounding the vehicle's horn, flashing the vehicle's lights, and disabling the vehicle's ignition system to render the vehicle inoperative.

One type of a known intrusion detection apparatus utilizes ultrasonic signals and the Doppler principle. For example the apparatus transmits a known frequency signal and monitors the frequency of a reflected signal to detect a change in frequency. A change in the frequency of the reflected signal may be caused by movement within a monitored area and is known as a Doppler shift.

It is possible that a known ultrasonic intrusion detection apparatus may experience a false alarm. Ideally, the apparatus should not detect non-intrusive events that occur within or around the monitored area. Examples of non-intrusive events include an inadvertent striking of the outside of the vehicle, motion near or around the vehicle, air turbulence within the protected area, and temperature changes within the protected area. Nevertheless, these non-intrusive events alter the reflected signal that is monitored by the ultrasonic intrusion detection apparatus. As a result, the non-intrusive event may be interpreted as being an intrusion and may result in a false alarm.

One known intrusion detection apparatus generates a reverberation field within a monitored space. The reverberation field includes a plurality of signals traveling along a plurality of propagation paths within the protected space. The apparatus detects the entry of a new object into the reverberation field or a change in position of an existing object in the reverberation field. An alarm signal is generated when the change in the reverberation field is greater than a predetermined threshold value.

### SUMMARY OF THE INVENTION

The present invention is an apparatus for detecting an intrusion into a predetermined area. The apparatus includes a transmitter and a receiver. The transmitter transmits a signal within the predetermined area. The receiver receives reflected return signals of the transmitted signal and generates an output signal indicative of the reflected return signals received. The apparatus also includes a controller. The controller receives the output signal from the receiver and determines a peak value of the output signal during a first time window. The first time window continues no longer than a first maximum duration when the peak value of the output signal during the first maximum duration is at least a predetermined value. The first time window continues no longer than a second maximum duration when the peak value of the output signal during the first maximum duration is less than the predetermined value. The peak value of the output signal is used in differentiating between an intrusion and a non-intrusion event.

In accordance with a second aspect, the present invention is a method of detecting an intrusion into a predetermined area. The method includes the steps of: (i) transmitting a signal within the predetermined area; (ii) receiving reflected return signals of the transmitted signal; (iii) generating an output signal indicative of the reflected return signals received; (iv) determining a peak value of the output signal during a first time window, the peak value for use in differentiating between an intrusion and a non-intrusion event; (v) closing the first time window after a first maximum duration when the peak value of the output signal during the first maximum duration is at least a predetermined value; and (vi) extending the first time window toward a second maximum duration when the peak value of the output signal during the first maximum duration is less than the predetermined value.

### BRIEF DESCRIPTION OF THE DRAWINGS

Further features and advantages of the present invention will become apparent to those skilled in the art from reading the following description with reference to the accompanying drawings, in which:

FIG. 1 is a schematic diagram of an apparatus, in accordance with the present invention, mounted on a vehicle ceiling;

FIG. 2 is a schematic block diagram of the apparatus of FIG. 1;

FIG. 3 is a schematic block diagram of the first envelope detecting circuit shown in FIG. 2;

FIG. 4 illustrates a non-intrusion reflected return signal and the resultant waveform envelope;

FIG. 5 illustrates an intrusion reflected return signal and the resultant waveform envelope;

FIG. 6 is a flowchart diagram showing a control process in accordance with the present invention;

FIGS. 7A and 7B are flowchart diagrams of the control process in accordance with the present invention during a first time window; and

FIG. 8 is flowchart diagram of the control process in accordance with the present invention during a second time window.

### DESCRIPTION OF AN EXAMPLE EMBODIMENT

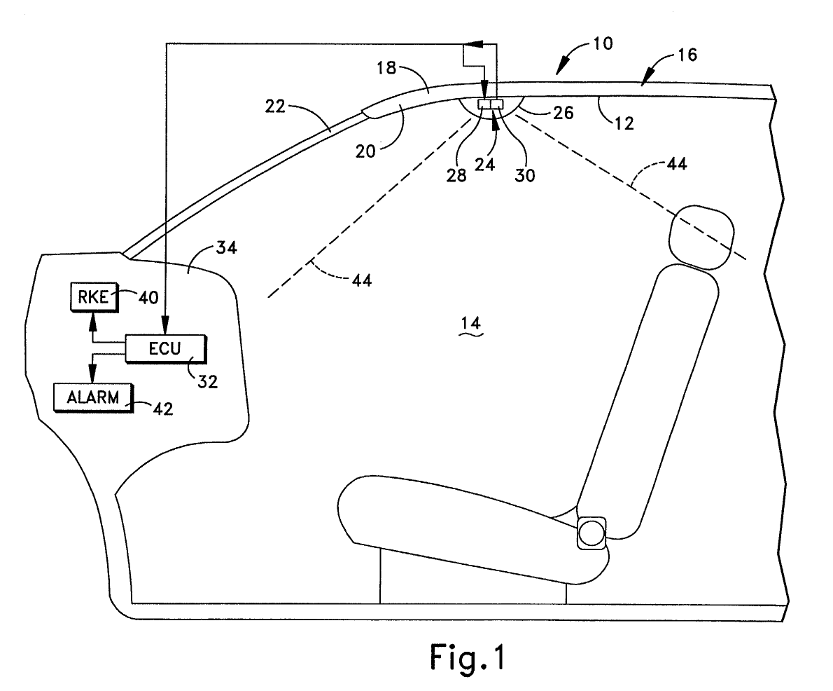

FIG. 1 illustrates schematically an intrusion detection apparatus 10, in accordance with the present invention, mounted to the ceiling 12 of the passenger compartment 14 of a vehicle 16. The ceiling 12 is formed by the interior of the roof 18. Alternatively, the apparatus 10 may be mounted at some other location within the vehicle passenger compartment 14, such as on a headliner 20, between front seats of the vehicle 16, or on a central portion of an upper edge of a front windshield 22. A suitable location is one that allows a signal that is transmitted by the apparatus 10 to cover a significant portion of the passenger compartment 14 of the vehicle 16.

The apparatus 10 includes a transceiver 24 that is mounted in an overhead console 26. Preferably, the transceiver 24 is an ultrasonic device that transmits and receives ultrasonic signals. As an alternative to an ultrasonic transceiver, an infrared transceiver may be used. The transceiver 24 includes a transmitter 28 and a receiver 30.

The transmitter 28 has a predetermined operating frequency. In an exemplary embodiment, the transmitter 28 is a NICERA piezo transducer AT/R40-10 with an operating frequency at 40 kHz. The operating frequency of the transmitter 28 is preferably greater than the human listening range (i.e., greater than 20 kHz).

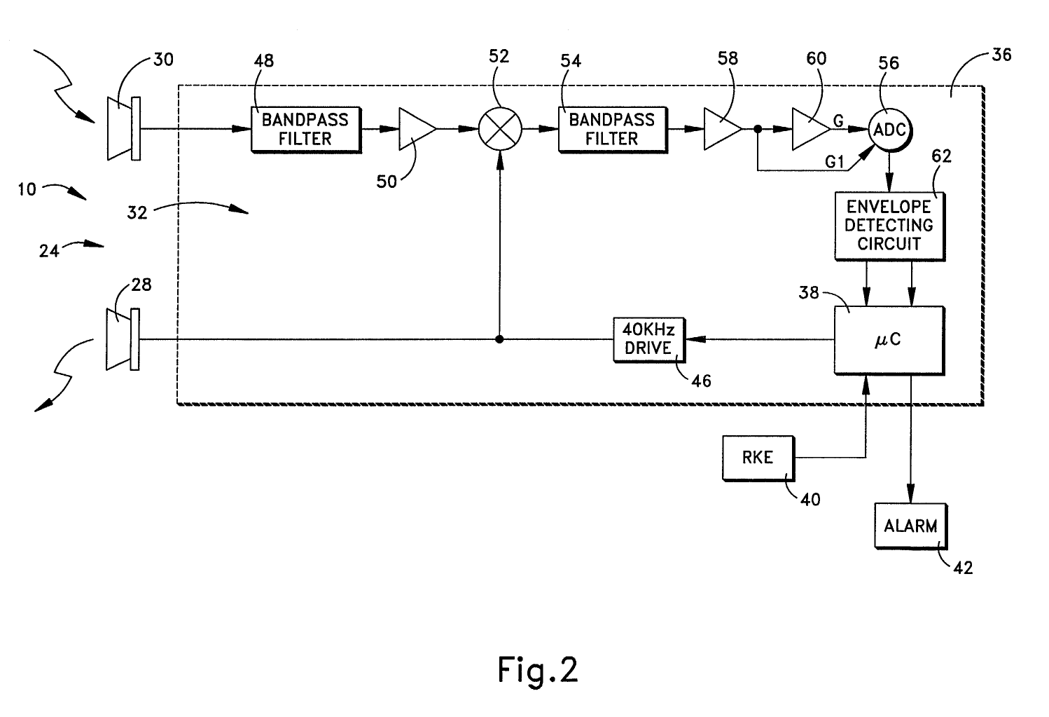

An electronic control unit 32 (“ECU”) is operatively connected to the transceiver 24. The ECU 32 is preferably located within the vehicle's instrument panel 34. Preferably, the ECU 32 includes a process circuit 36 (FIG. 2) and a controller 38 (FIG. 2). The process circuit 36 includes a plurality of discrete circuits and circuit components. The ECU 32 controls the transceiver 24 and, after receipt of the reflected signals from the receiver 30, discriminates between an intrusion into the passenger compartment 14 and a non-intrusion event.

The controller 38 includes a switching element (not shown) that is actuatable to enable and disable the apparatus 10. One method of actuating the switching element is by a remote keyless entry (“RKE”) system. The receiver of the RKE system is indicated in FIGS. 1 and 2 at 40. The RKE system allows the vehicle operator to disable the apparatus 10 before entering the vehicle 16 and to enable the apparatus 10 upon exiting the vehicle 16.

An alarm 42 is operatively connected to and is controlled by the ECU 32. Upon detection of an intrusion into the passenger compartment 14 of the vehicle 16, the controller 38 provides an alarm signal to actuate the alarm 42. The alarm 42 may include the sounding of the vehicle's horn, flashing of the vehicle's lights, and disabling of the vehicle's ignition system. Of course, it is to be appreciated that the alarm may provide for any other suitable function (e.g., remote notification, etc.) that is associated with intrusion detection.

When the apparatus 10 is enabled, the transceiver 24 transmits and receives ultrasonic signals. Preferably, the transmitter 28 of the transceiver 24 transmits continuous wave (“CW”) signals as beams, indicated at 44 in FIG. 1. The beams 44 are transmitted throughout the passenger compartment 14 of the vehicle 16. The beams 44 reflect off of objects in the passenger compartment 14 of the vehicle 16 and travel throughout the passenger compartment 14. Portions of the reflected signals return to the receiver 30. As a result, the receiver 30 receives a single wave return signal that is a superposition of all the reflected signals received by the receiver 30. Generally, the return signal received by the receiver 30 has the same frequency as the transmitted signal, but has phase and amplitude that vary from the transmitted signal. The phase and amplitude of the return signal are dependent upon the phase and amplitude of the various reflected signals added together at the receiver 30 to form the return signal.

The frequency, amplitude, and phase of the return signal received by the receiver 30 can be expected to remain constant over time if there is no motion within the passenger compartment 14 and the temperature within the passenger compartment 14 remains constant. However, motion in the passenger compartment 14 or a change in temperature within the passenger compartment 14 alters the reflected signals and, thus, the return signal received at the receiver 30. Motion within the passenger compartment 14 of the vehicle 16 results in a Doppler shift in the frequency of the signals reflected off of the object in motion. A Doppler shift in the frequency of some of the reflected signals alters the frequency, amplitude, and phase of the return signal received by the receiver 30.

During operation of the apparatus 10, the CW signals transmitted from the transmitter 28 reflect off of objects, stationary or moving (i.e., an intruder), within the passenger compartment 14 of the vehicle 16. As described above, the receiver 30 receives a portion of the reflected signals. Upon receipt of the reflected signals, the receiver 30 outputs an output signal to the ECU 32. The ECU 32 processes the output signal from the receiver 30 to determine a waveform envelope of the output signal. The ECU 32 then determines whether the waveform envelope is indicative of an intrusion into the passenger compartment 14 or a non-intrusion event.

FIG. 2 is a functional block diagram illustrating the ECU 32. The ECU 32 includes the process circuit 36 and the controller 38. The process circuit 36 includes an oscillating drive circuit 46. The oscillating drive circuit 46 generates a CW signal that is applied to the transmitter 28 of the transceiver 24. This CW signal can be either a square or a sinusoidal waveform. Preferably, the oscillating drive circuit 46 generates a 40 kHz signal that drives the transmitter 28 and results in the transmitter 28 transmitting a continuous wave ultrasonic signal at 40 kHz into the passenger compartment 14 of the vehicle 16.

The ultrasonic wave signals transmitted by the transmitter 28 reflect off of objects within the passenger compartment 14 of the vehicle 16. As a result, a reverberation field is established within the passenger compartment 14 of the vehicle 16. As stated above, the receiver 30 receives reflected return signals and generates an output signal.

The receiver 30 sends the output signal into the process circuit 36. The output signal is input into a bandpass filter 48. The bandpass filter 48 eliminates noise not associated with the intrusion effects to be detected by the apparatus 10 and prevents the output signal from overloading a pre-amplifier 50. The bandpass filter 48 passes the filtered output signal to the pre-amplifier 50. The pre-amplifier 50 amplifies the output signal and passes the output signal to a synchronous demodulator 52. The output of the oscillating drive circuit 46 is also connected to the synchronous demodulator 52.

The demodulator 52 synchronously demodulates the output signal with the CW drive signal from the oscillating drive circuit 46. The CW drive signal from the oscillating drive circuit 46 is used as the demodulation reference. The demodulator 52 extracts frequency and amplitude components of the output signal that would indicate motion of an object in the passenger compartment 14 of the vehicle 16.

The demodulated output signal passes to a second bandpass filter 54. The second bandpass filter 54 removes the DC background from the demodulated output signal. The lower limit of the second bandpass filter 54 may be below 1 Hz and the upper limit is selected to be greater than the expected frequency that would result during an intrusion. The upper limit must be low enough, however, to provide some noise rejection and anti-aliasing of an analog-to-digital converter 56 (“ADC”) used to further process the output signal. Preferably, the lower limit of the second bandpass filter 54 is 10 Hz and the upper limit is 400 Hz. The 10 Hz lower limit removes DC background noise associated with temperature changes and air circulation. The 400 Hz upper limit allows detection of objects moving at a rate of up to 2 meters per second and avoids aliasing the ADC 56.

The output signal passes from the second bandpass filter 54 to a first post-amplifier 58. The first post-amplifier 58 amplifies the output signal with a first gain G₁. The output of the first post-amplifier 58 is input into both the ADC 56 and a second post-amplifier 60. The second post-amplifier 60 further amplifies the output signal with a second gain G₂. The output of the second post-amplifier 60 is input into the ADC 56. The total gain G of the output signal passing through both the first and second post-amplifiers 58 and 60 is G₁ multiplied by G₂.

The first and second post-amplifiers 58 and 60 allow the gain of the output signal to be adjusted between a high gain and a low gain. For highest sensitivity of intrusion detection, a high gain is preferred. However, the high gain may distort certain signals and output a saturated signal that may result in a false alarm. When the controller 38 receives a signal that is saturated, the controller 38 can switch from monitoring the high gain signal to monitoring the low gain signal. The low gain signal will not be saturated and will allow for a correct determination of an intrusion or a non-intrusion event.

Preferably, the ADC 56 has a sample rate of 1 kHz. The sample rate of the ADC 56 should be more than twice the highest signal frequency passing through the second bandpass filter 54. The ADC 56 passes the digitized value of the output signal to an envelope detecting circuit 62. The envelope detecting circuit 62 could be implemented in digital form as an algorithm running on the controller 38. The envelope detecting circuit 62 determines a waveform envelope of the output signal.

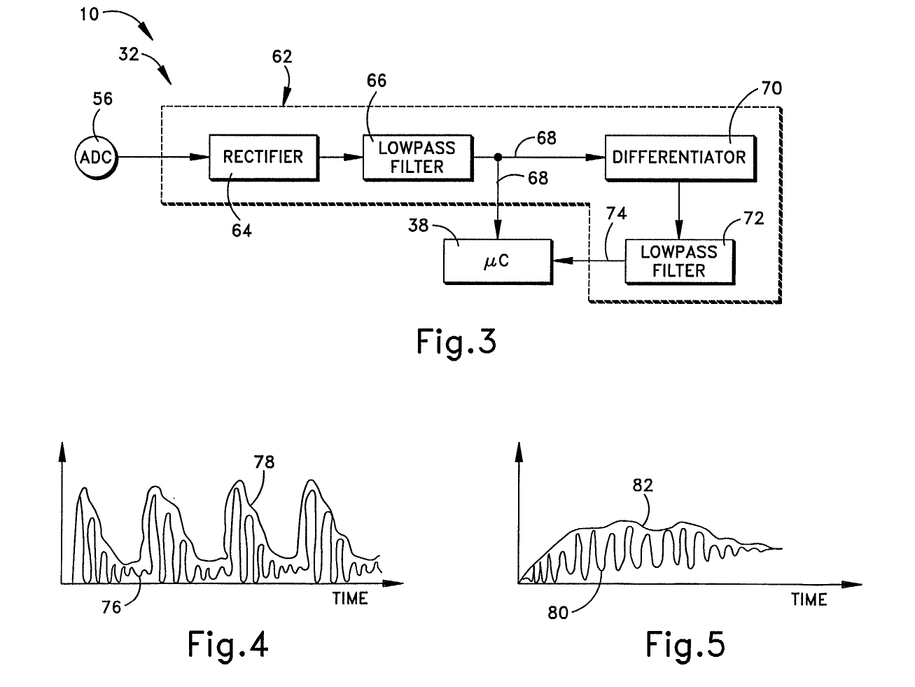

FIG. 3 illustrates an example embodiment of the envelope detecting circuit 62. The envelope detecting circuit 62 includes a rectifier signal processing means 64 for digitally rectifying the demodulated output signal. The envelope detecting circuit 62 also includes a low-pass filter 66. One type of low-pass filter 66 that may be used is a recursive filter that achieves a long impulse response without having to perform a long convolution. The recursive filter removes noise jitters or spikes from the rectified output signal.

The rectified output signal, after being filtered by the low-pass filter is indicated in FIG. 3 at 68. The output signal 68 is then input into both the controller 38 and a combination of a differentiator 70 and a low-pass filter 72. The combination of the differentiator 70 and the low-pass filter 72 generates a filtered derivative value of the output signal, indicated at 74 in FIG. 3. The filtered derivative value 74 of the output signal is also input into the controller 38.

FIG. 4 illustrates a time representation a return signal 76 for a non-intrusive event, e.g., four thumps on the outside of a vehicle window. The waveform envelope 78 for the non-intrusive event is also shown. The waveform envelope 78 is a harmonic signal with a rapid rise time followed by a slower, but also rapid, decay time. Normally, a non-intrusion event does not occur regularly so as to generate a continuous waveform envelope such as that illustrate in FIG. 4. Typically, the non-intrusion event forms a plurality of spaced waveform envelopes. When a non-intrusion event occurs, the time between the rise of the waveform envelope above a predetermined level and the decay of the waveform envelope below the predetermined level is less than 250 milliseconds.

FIG. 5 illustrates a time representation of a return signal 80 for an intrusion. The waveform envelope 82 for the intrusion is also shown. The waveform envelope 82 is a harmonic signal with a slow rise time. As long as motion continues during the intrusion, the waveform envelope 82 is continuous with an amplitude greater than the predetermined level. Thus, the waveform envelope for an intrusion has an amplitude above the predetermined level for a time period of greater than 250 milliseconds.

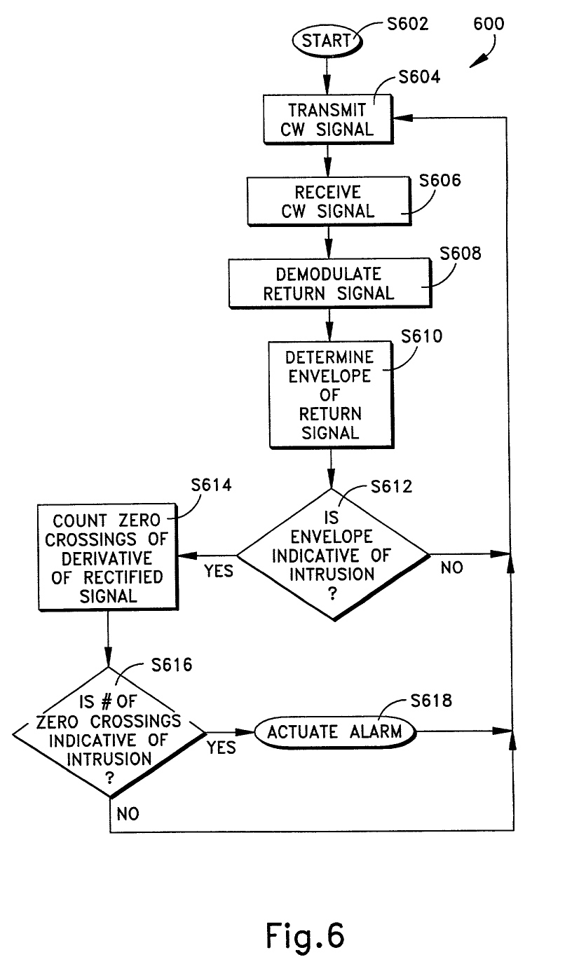

FIG. 6 illustrates a control process 600, in accordance with the present invention, for determining the existence of an intrusion or a non-intrusion event into the passenger compartment 14 of the vehicle 16. The process 600 begins at step S602 where memories are cleared, initial flag conditions are set, etc., in a manner known in the art. The process 600 then proceeds to step S604 where the transmitter 28 transmits a continuous wave signal within a predetermined area, i.e., the passenger compartment 14 of the vehicle 16. From step S604, the process 600 proceeds to step S606. At step S606, the receiver 30 receives the reflected return signals. The process 600 next proceeds to step S608. At step S608, the output signal from the receiver 30 is demodulated. At step S610, the waveform envelope of the demodulated output signal is determined. From step S610, the process 600 proceeds to step S612.

At step S612, a determination is made as to whether the waveform envelope is indicative of an intrusion or a non-intrusion event. If in step S612, the waveform envelope is determined to indicate a non-intrusion event, the process returns to step S604. If in step S612, the waveform envelope is determined to indicate an intrusion, the process 600 proceeds to step S614. At step S614, a count is taken of the zero crossings of the derivative 74 of the rectified signal. The frequency of the output signal can be determined by the number of zero crossings of the derivative 74 of the rectified signal. From step S614, the process 600 proceeds to step S616. At step S616, a determination is made as to whether the number of zero crossings of the derivative 74 of the rectified signal is indicative of an intrusion. If the determination at step S616 is negative, the process 600 returns to step S604. If the determination at step S616 is affirmative, the process 600 proceeds to step S618, where the alarm 42 is actuated. From step S618, the process 600 proceeds to step S604 and the process 600 is repeated.

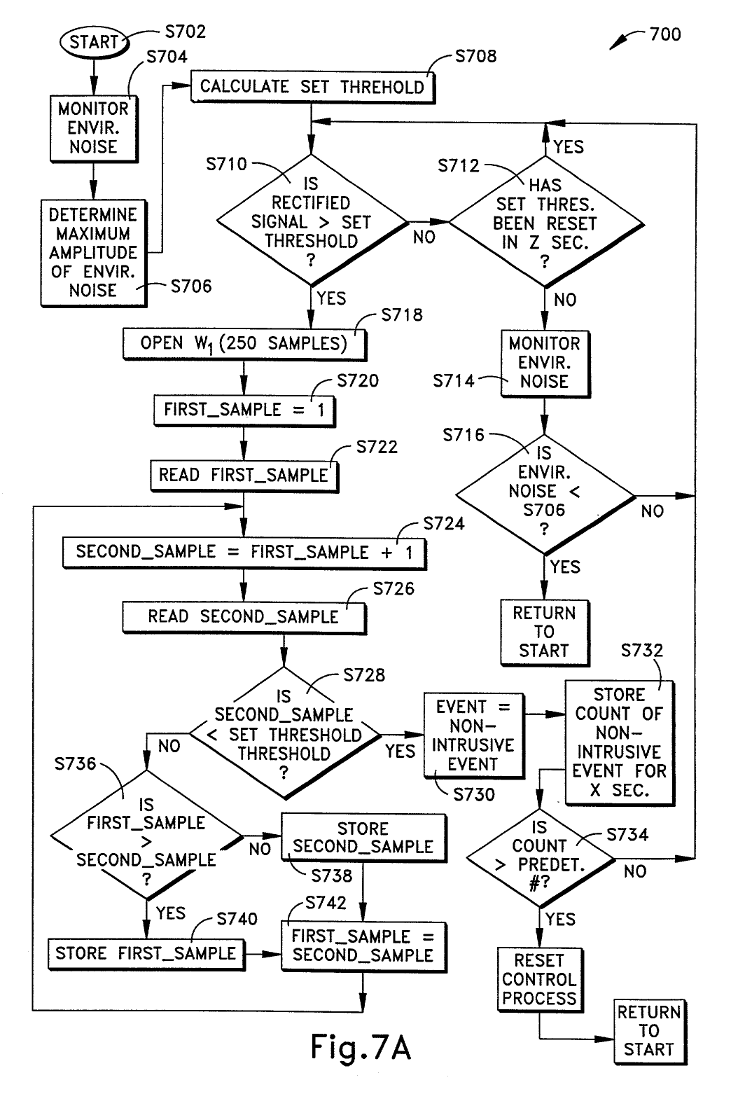

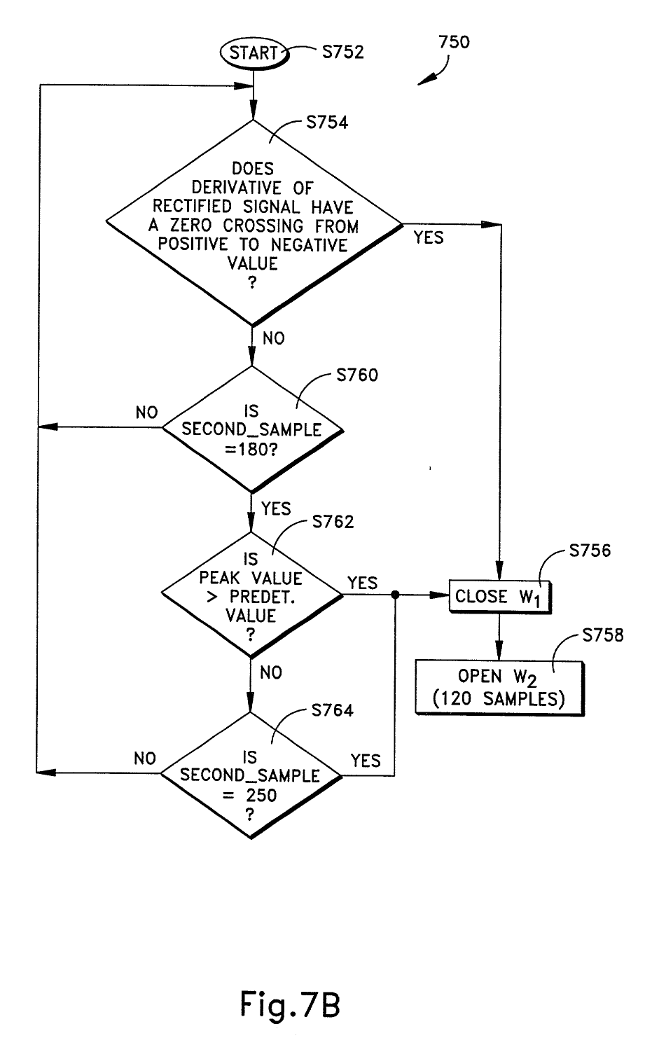

FIG. 7A illustrates a control process 700 that is performed by the controller 38 to accomplish the step indicated at step S612 in FIG. 6. This control process 700 monitors the waveform envelope by dividing the waveform envelope into time windows. Each time window includes a predetermined number of time sampled values. Each of the time sampled values is indicative of the amplitude of the waveform envelope at the time the sample value is taken. The amplitude of the waveform envelope at a particular point in time is the value of the rectified return signal 68 at that point in time. The time sampled values are analyzed and compared against predetermined thresholds.

Since the waveform envelope of a non-intrusion event has a rapid rise time compared to a signal from an intrusion, the first time window W₁ is used to determine the presence of a false alarm or a non-intrusion event. As will be discussed below, an intrusion is not determined, in accordance with the present invention, until after a second time window W₂ is opened.

From empirical data, it has been determined that a waveform envelope of a non-intrusion event takes between 100 to 200 milliseconds to reach a peak value and between 100 to 150 milliseconds to decay below a decay threshold. It has also been determined that a waveform envelope of an intrusion is sustained above the decay threshold for over 300 milliseconds.

The control process 700 of FIG. 7A begins at step S702 where internal memories of the controller 38 are reset, flags are set to initial conditions, etc. in a manner well known in the art. At step S704, environmental noises received by the receiver are monitored. Environmental noises can affect the signals received by the receiver and may result in false alarms. From step S704, the process 700 proceeds to step S706. At step S706, the maximum amplitude of the environmental noise is determined. The process 700 then proceeds to step S708 where a set threshold is calculated. The set threshold is computed by adding a margin of safety to the maximum amplitude of the environmental noise. Setting the set threshold based upon the environmental noise received immediately after the apparatus 10 is enabled assumes that the vehicle 16 is free from intrusion for a few moments after the apparatus 10 is enabled. Setting the set threshold based upon environmental noise also prevents false alarms by allowing the threshold to be adapted to different environments. From step S708, the process 700 proceeds to step S710.

At step S710, the value of the rectified output signal 68 is repeatedly evaluated at a predetermined rate. The values 68 are sequentially processed. The value 68 of the rectified output signal is compared against the calculated set threshold from step S708 and a determination is made as to whether the value 68 of the rectified output signal exceeds the set threshold from step S708. If the value 68 of the rectified output signal exceeds the set threshold and if the low-pass filtered derivative signal 74 (FIG. 3) exceeds a predetermined positive threshold, the process 700 proceeds to step S718. If the determination in step S710 is negative, the process 700 proceeds to step S712.

In step S712, a determination is made as to whether the set threshold has been reset in a predetermined time period, for example 300 seconds. If the set threshold has been reset within the predetermined time period, the process 700 returns to step S710. If the set threshold has not been reset within the predetermined time period, the process 700 proceeds to step S714 where the environmental noise is again monitored. At step S716, a determination is made as to whether the environmental noise from step S714 has an amplitude that is less than the amplitude of the environmental noise from step S706. If the determination in step S716 is negative, the process 700 returns to step S710. If the determination in step S716 is affirmative, the process 700 proceeds to step S702 and a new set threshold is calculated.

At step S718, a first time window W₁ is opened (i.e., a first time period begins to run). As will be discussed below, the first time window W₁ is open for a time sufficient to permit a maximum of 250 samples of the rectified output signal. From step S718, the process 700 proceeds to step S720.

At step S720, a FIRST_SAMPLE pointer is initialized to equal a time position for the first sample of the rectified output signal during the first time window W₁. From step S720, the process 700 proceeds to step S722. At step S722, the process 700 reads a FIRST_SAMPLE, X_{FIRST}_{_{—}}_{SAMPLE} of the rectified output signal 68. At step S724, a SECOND_SAMPLE pointer is initialized to equal the time position for the second sample of the rectified return signal 68 during the first time window W₁. In a preferred embodiment, what is referred to as the SECOND_SAMPLE pointer value ranges from 2 to 250 when the first time window W₁ is divided into 250 time positions. At step S726, the process 700 reads a second sample, X_{SECOND}_{_{—}}_{SAMPLE}, of the rectified output signal 68 at the next pointer (time position). From step S726, the process proceeds to step S728.

At step S728, a determination is made as to whether the second sample read is less than the calculated set threshold (step S708). If the determination is affirmative, the process 700 proceeds to step S730 where the EVENT status is determined to be a non-intrusive event. The process 700 then proceeds to step S732. At step S732, the process 700 stores a count of the number of non-intrusion events that occur during a specified time period, i.e., 300 seconds. The process 700 then proceeds to step S734. At step S734, a determination is made as to whether the count from step S732 is greater than a predetermined number, i.e., 3 times. If the count is above the predetermined number during the specified time, the control process 700 resets, i.e., the subroutine process ends and returns to step S702. A new set threshold is calculated, and the process 700 proceeds as described above. If the determination is negative, from step S734, the process 700 returns to step S710. If the determination from step S728 is negative, the process proceeds to step S736.

At step S736, a determination is made as to whether the value of the FIRST_SAMPLE is greater than the value of the SECOND_SAMPLE. If X_{FIRST}_{_{—}}_{SAMPLE} is less than or equal to X_{SECOND}_{_{—}}_{SAMPLE}, the process proceeds to step S738. When the value of the SECOND_SAMPLE is greater than the value of the FIRST_SAMPLE, the rectified output signal 68 is increasing. At step S738, the X_{SECOND}_{_{—}}_{SAMPLE} value is stored. If the value of the FIRST_SAMPLE is greater than the value of the SECOND_SAMPLE, meaning that the rectified output signal is decreasing in value, the process 700 proceeds to step S740. At step S740, the process 700 stores X_{FIRST}_{_{—}}_{SAMPLE} value. From step S738 or step S740, the process 700 proceeds to step S742.

At step S742, the SECOND_SAMPLE now becomes the FIRST_SAMPLE and the process 700 loops back to step S724. At step S724, the position pointer of the SECOND_SAMPLE is moved to the next pointer position (time location) in the first time window W₁. At step S726, the process 700 reads a new SECOND_SAMPLE value, X_{SECOND}_{_{—}}_{SAMPLE}, which is equal to the previous SECOND_SAMPLE value plus one. As a result, the process 700 successively compares, throughout the samples of the first time window W₁, the value of one sample point within the first time window W₁ with the value of a subsequent sample point within the first time window W₁. The process 700 also monitors and stores the largest sample value of the two sample values compared.

Once the process 700 stores either a first or second sample value, at step S738 or S740, the process 700 then starts the subroutine control process 750 that is illustrated in FIG. 7B. The subroutine control process 750 is used to determine whether the first time window W₁ should be closed and a second time window W₂ opened.

Process 750 of FIG. 7B is initiated at step S752 and proceeds to step S754. At step S754, a determination is made as to whether the derivative 74 of the rectified output signal (FIG. 3) has a zero crossing from positive to negative. If the determination in step S754 is affirmative and the derivative 74 of the rectified output signal does have a zero crossing from positive to negative, then the process 750 proceeds to steps S756 and S758 where the first time window W₁ is closed and the second time window W₂ is opened. If the derivative 74 of the rectified output signal does not have a zero crossing from positive to negative, the process 750 proceeds to step S760.

At step S760, a determination is made as the whether the total number of samples within the first time window W₁ equals a first maximum number of time samples, i.e., the first time window W₁ has been open for a first maximum duration, preferably 180 milliseconds. If the total number of samples does not equal the first maximum number of samples, the process 750 returns to step S754. If the total number of samples does equal the first maximum number of samples, the process proceeds to step S762.

At step S762, the determination is made as to whether the peak value of the rectified output signal 68 monitored during the first maximum duration is greater than a predetermined value. If the determination in step S762 is affirmative, the process 750 proceeds to steps S756 and S758 where the first time window W₁ is closed and the second time window W₂ is opened. If the process 750 from step S762 is negative, the process 750 proceeds to step S764 where a determination is made as to whether the total number of samples within the first time window W₁ equals a second maximum number of time samples, i.e., the first time window W₁ has been open for a second maximum duration, preferably 250 milliseconds. If the determination in step S764 is affirmative, the process 750 proceeds to steps S756 and S758 where the first time window W₁ is closed and the second time window W₂ is opened. If the determination in step S764 is negative, the process 750 returns to step S754.

Thus, the process 750 of FIG. 7B sets forth three factors that result in the first time window W₁ closing and the second time window W₂ opening. First, if the derivative 74 of the rectified signal has a zero crossing from positive to negative, the first time window W₁ is closed and the second time window W₂ is opened. Second, if the first time window W₁ has been open for the first maximum duration, 180 milliseconds, and the peak value of the rectified signal 68 is greater than a predetermined value, then the first time window W₁ is closed and the second time window W₂ is opened. Third, if the first time window W₁ has been open for the second maximum duration, then the first time window W₁ is closed and the second time window W₂ is opened.

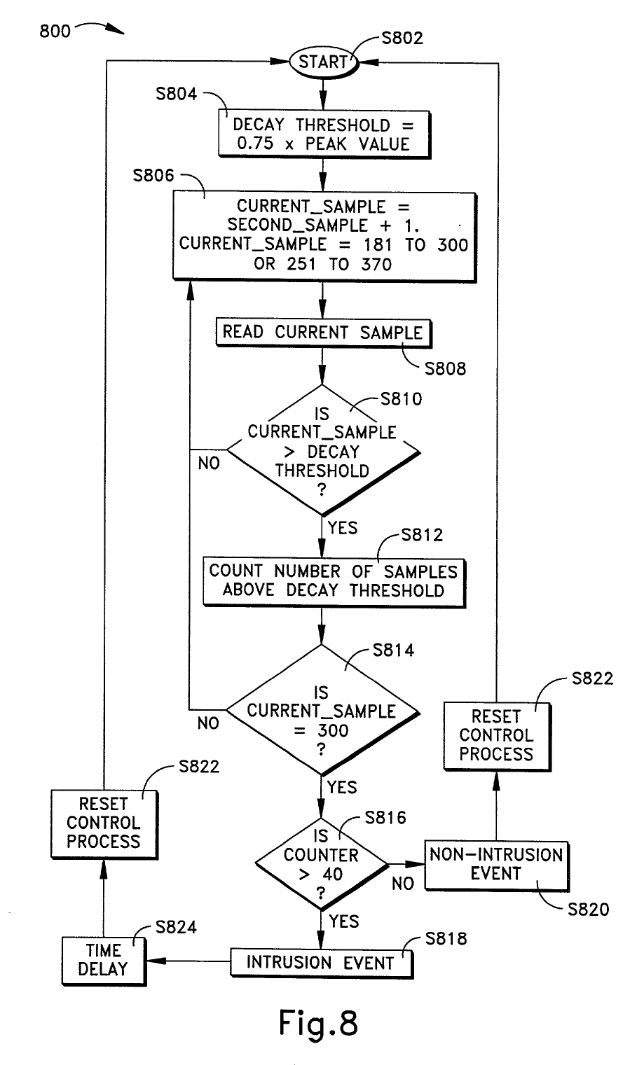

In a preferred embodiment, the time period of the second time window W₂ is equal to 120 milliseconds. The algorithm implemented to evaluate the second time window W₂ is shown in FIG. 8. The process 800 is initiated at step S802 and proceeds to step S804. At step S804, a decay threshold is calculated. Preferably, the decay threshold is equal to 0.75 times the maximum peak value monitored and stored during the first time window W₁. From step S804, process 800 proceeds to step S806. A current sample value is a value 68 of the rectified output signal at a point in time when the second time window W₂ opens. As a result, at step S806 the current sample indicator is set to equal to the point in time where the first time window W₁ closes and increments that point by one. Thus, if the first time window W₁ stayed open for the first maximum duration of 180 time samples, the pointer would then be at 181. However, if the first time window W₁ was open for the second maximum duration of 250 time samples, the pointer would be at 251. From step S806, the process 800 proceeds to step S808.

At step S808, the first sample within the second time window W₂ is read, i.e., the rectified output signal value 68 is measured. From step S808, the process 800 proceeds to step S810 where a determination is made as to whether the first sample within the second time window W₂, now the current sample, is greater than the decay threshold value. If the determination is negative and the current sample is not greater than the decay threshold value, the process 800 returns to step S806. If the determination is affirmative, i.e., the current sample is greater than the decay threshold, the process 800 proceeds to step S812. At step S812, the number of samples of the rectified output signal in the second time window W₂ that are above the decay threshold are counted. From step S812, the process 800 proceeds to step S814.

At step S814, a determination is made as to whether the current sample is at 300. If the determination at step S814 is negative, the process 800 returns to step S806. If the determination at step S814 is affirmative, the process 800 goes to step S816.

At step S816, a determination is made as to whether the number of samples within the second time window W₂ above the decay threshold (the count of step S812) exceeds a predetermined number. For illustrative purposes, the preset number is equal to 40 samples. If the number of samples within the second time window W₂ exceeds 40 samples, then the process 800 proceeds to step S818 where an intrusion event flag is set. If the number of samples within the second time window W₂ does not exceed 40 samples, the process 800 proceeds to step S820 where a non-intrusion event flag is set.

Thus, during the first time window W₁, the maximum value, or peak, of the waveform envelope formed by the rectified output signal is determined. During the second time window W₂, the width of the waveform envelope that is above the decay threshold is determined. The determination of an intrusion is dependent upon the width of the waveform envelope above the decay threshold.

After the determination of an intrusion or a non-intrusion event, step S818 or S820, the process 800 is reset. If a non-intrusion event is determined, the process 800 proceeds to step S822 and is reset immediately by returning to step S724 of FIG. 7A. If an intrusion event is determined, the process 800 proceeds to step S824, where a time delay occurs. From step S824, the process 800 goes to step S822 where the control process is reset by returning to step S724 of FIG. 7A.

The apparatus 10 of the present invention may also include a self-testing feature. Upon enabling the apparatus 10, the transmitter 28 is turned on and then off and a short-signal is transmitted into the passenger compartment 14 of the vehicle 16. The receiver 30 receives the signal and the signal is processed. The controller 38 compares the signal received to an exemplary signal. If the signal received by the receiver 30 is similar to the exemplary signal, then the apparatus 10 is found to be functioning properly. If the signal is found to vary from the exemplary signal, then the apparatus 10 is found to be malfunctioning and the apparatus 10 is disabled.

Although the foregoing description has specifically applied the apparatus 10 of the present invention to detecting an intrusion into the passenger compartment 14 of a vehicle 16, the apparatus 10 may be used to detect an intrusion into any predefined area.

From the above description of the invention, those skilled in the art will perceive improvements, changes and modifications. Such improvements, changes and modifications within the skill of the art are intended to be covered by the appended claims.

Having described the invention, we claim the following:

1. An apparatus for detecting an intrusion into a predetermined area, the apparatus including:
a transmitter transmitting a signal within the predetermined area;
a receiver receiving reflected return signals of the transmitted signal and generating an output signal indicative of the reflected return signals received; and
a controller receiving the output signal from the receiver and determining a peak value of the output signal during a first time window, the first time window continuing no longer than a first maximum duration when the peak value of the output signal during the first maximum duration is at least a predetermined value, the first time window continuing no longer than a second maximum duration when the peak value of the output signal during the first maximum duration is less than the predetermined value;
the peak value of the output signal being used in differentiating between an intrusion and a non-intrusion event.

2. The apparatus as defined in claim 1 further including a processor for processing the output signal between the receiver and the controller, the processor including an envelope detecting circuit for determining a waveform envelope of the output signal.

3. The apparatus as defined in claim 2 wherein the processor includes first and second amplifiers, the first amplifier amplifying the output signal with a first gain and outputting a first amplified output signal, the first amplified output signal being input into both the second amplifier and the controller, the second amplifier further amplifying the first amplified output signal with a second gain and outputting a second amplified output signal to the controller, the controller using the second amplified output signal to determine the peak value when the second amplified output signal is unsaturated and, the controller using the first amplified output signal to determine the peak value when the second amplified output signal is saturated.

4. The apparatus as defined in claim 2 wherein the envelope detecting circuit outputs a rectified value and a derivative value of the waveform envelope at various time samples of the first time window, the first time window ending if the derivative value at any time sample has a zero crossing from positive to negative.

5. The apparatus as defined in claim 4 wherein the controller counts the zero crossings of the derivative value during the first time window to determine a frequency of the output signal, the controller also determining if the frequency of the output signal is indicative of an intrusion or of a non-intrusion event.

6. The apparatus as defined in claim 1 wherein the controller includes a switching element that is actuatable to enable the apparatus and to disable the apparatus.

7. The apparatus as defined in claim 6 wherein the controller also includes a comparator, when the switching element is actuated to enable the apparatus the transmitter sending out a short test signal, the receiver receiving a return signal from the test signal, the comparator comparing the return signal to an exemplary signal to determine if the apparatus is properly functioning.

8. The apparatus as defined in claim 6 wherein the receiver monitors environmental noises for a short duration after the apparatus is enabled, the receiver sending a signal indicative of the environmental noises to the controller, and the controller setting a set threshold based upon a maximum amplitude of the environmental noises, the controller opening the first time window when the output signal from the receiver exceeds the set threshold.

9. A method of detecting an intrusion into a predetermined area, the method including the steps of:
transmitting a signal within the predetermined area;
receiving reflected return signals of the transmitted signal;
generating an output signal indicative of the reflected return signals received;
determining a peak value of the output signal during a first time window, the peak value for use in differentiating between an intrusion and a non-intrusion event;
closing the first time window after a first maximum duration when the peak value of the output signal during the first maximum duration is at least a predetermined value; and
extending the first time window toward a second maximum duration when the peak value of the output signal during the first maximum duration is less than the predetermined value.

10. The method as defined in claim 9 further including the steps of:
amplifying the output signal with a first gain to form a first amplified output signal;
amplifying the first amplified output signal with a second gain to form a second amplified output signal;
analyzing the second amplified output signal if the second amplified output signal is unsaturated; and
analyzing the first amplified output signal when the second amplified output signal is saturated.

11. The method of claim 9 further including the steps of:
processing the output signal into a waveform envelope;
determining a rectified value for the waveform envelope at various time samples of the first time window;
determining a derivative value for the waveform envelope at the various time samples of the first time window; and
closing the first time window when a derivative value at any of the various time samples has a zero crossing from positive to negative.

12. The method of claim 11 further including the steps of:
counting the zero crossings of the derivative value,
determining a frequency of the output signal based upon the zero crossings of the derivative value, and
determining if the frequency is indicative of an intrusion or a non-intrusion event.

13. The method of claim 9 wherein prior to determining a peak value of the output signal, the method includes the steps of:
transmitting a test signal into the predetermined area;
receiving a return signal from the test signal; and
comparing the received signal to an exemplary signal.

14. The method of claim 13 further including the step of:
discontinuing the transmission of signals if the received signal is not similar to the exemplary signal.

15. The method of claim 9 wherein prior to determining a peak value of the output signal, the method includes the steps of:
monitoring environmental noises for a short duration;
determining a maximum amplitude of the environmental noises;
establishing a set threshold based upon the maximum amplitude of the environmental noises; and
opening the first time window when the output signal exceeds the set threshold.

16. The method of claim 15 further including the steps of:
monitoring a time lapse since the set threshold was established;
monitoring environmental noises if the output signal has not exceeded the set threshold in a predetermined time limit; and
lowering the set threshold if a maximum amplitude of the environmental noises has decreased.

17. The method of claim 15 further including the steps of:
counting a number of non-intrusion events detected during a predetermined time limit;
comparing the number of non-intrusion events to a predetermined number; and
increasing the set threshold if the number of non-intrusion events is greater than the predetermined number.
